(19) United States
(12) Patent Application Publication
(10) Pub. No.: US 2008/0098388 A1
(43) Pub. Date: Apr. 24, 2008

(54) Safe Flashing

(75) Inventors: Arnaud Frank Wilhelmine Gouder De Beauregard, Eindhoven (NL); Justin Francois Paul-Marie Frints, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,785

(22) PCT Filed: Jun. 23, 2005
(86) PCT No.: PCT/IB05/52069

§ 371 Date: Dec. 18, 2006

(30) Foreign Application Priority Data
Jun. 29, 2004 (EP) 04103028.9

(51) Int. Cl. G06F 9/445

(52) U.S. Cl. 717/174

(57) ABSTRACT

In accordance with the present invention, when a flashing is initiated a flashcode can be uploaded (310) to a flash only area of a reprogrammable non-volatile storage medium. Then, it is verified (320) whether the flashcode has been uploaded correctly to the flash only area. If the flashcode has not been uploaded correctly, the flashcode will be uploaded (310) to the flash only area again. When the flashcode has been uploaded correctly, a code segment of said reprogrammable non-volatile storage medium can be flashed (330) with new code in the next step. Thereafter, it is verified (340) whether the new code has been correctly written into the code segment. If the code was not satisfactorily written into the code segment, the code segment is flashed (330) again.

This invention relates in general to the field of flashing storage mediums. In particular the invention relates to the field of flashing reprogrammable non-volatile storage mediums in a safe manner. Furthermore it relates to the field of recovering the flashing in events when the flashing operation is interrupted, e.g. when the power fails during the flashing operation. The invention is intended to be exploited in any computer system, which uses storage medium that can be flashed. In particular, the invention could be exploited in optical drives.

It should be emphasized that the term computer, when used throughout this specification and claims is taken to specify any electronic device that can store, retrieve and process data. Therefore, when referring to the term computer system, this term is taken to specify any system that comprises processing means, storage means, input means, output means, and power supply. Accordingly, the term computer system intends to include any type of computers, personal computers, mobile cellular telephones, smartphones, Personal Digital Assistants (PDAs), electronic equipment, smart electronic appliances and equipment for kitchen, cleaning and outdoor use, consumer electronics, imaging equipment such as for example digital cameras, etc. when these comprise processing means, storage means, input means, output means, and power supply.

Furthermore, it should be emphasized that throughout this specification and claims a storage medium comprises a plurality of segments. In turn, each segment comprises a plurality of blocks, each block being of a size of 8-Kbyte, 16-Kbyte, 32-Kbyte, 64-Kbyte, etc.

Moreover, in the following specification and claims the term comprises/comprising should be interpreted as “including, but not limited to . . . ”. That is, when used throughout this specification and claims, this term is taken to specify the presence of stated features, integers, components or steps but does not preclude the presence or addition of one or more features, integers, components or steps.

The hardware in a basic computer system can be said to include five components; main memory means, processing means, secondary memory means, input means, and output means. The main memory means and the processing means together form the central processing means, often referred to as the CPU (central processing unit). The CPU is the most important part of the computer system and the processing of program and data is performed in this part. The other hardware that form parts of the computer system is often referred to as peripherals.

Computer systems include various types of storage means also referred to as storage medium. Some storage mediums are volatile meaning that the code or data stored on the storage medium is lost once the power is turned off to the storage medium. One well-known type of a volatile storage medium is the Read/Write memory (RWM). RWM gives the user the possibility to change program and data or make changes in data areas of the memory.

Other storage mediums are non-volatile meaning that they retain their code or data even if power is turned off to the storage medium.

Storage mediums are used for a variety of purposes. For instance, non-volatile storage mediums, such as for example dynamic random access memory (DRAM), or more specifically synchronous dynamic random access memory (SDRAM) are typically used as main system memory of computers. Upon boot up (i.e. start), the operating system of computers is copied into the main system memory and executed by the processor from that memory. As the user opens applications, each application is also copied from the storage drive (e.g. hard drive, CD-ROM drive, DVD drive, BluRay Disc Drive), on which the application is permanently stored, into the main system memory for execution. Main system memory is also used to temporarily store data, configuration information and other types of information that the computer may use during operation.

Non-volatile storage mediums are useful for storing executable code that the computer may execute each time it is powered up. Such code is referred to as “firmware”. Firmware is so called since it lies somewhere between hardware and software. It includes microprograms, programs and routines stored on the recordable storage medium. By way of example, most computers include some set of executable routines called BIOS (Basic Input/Output System), which provide access to various input/output means such as for example CD-ROM drives, floppy disk drives and displays. The BIOS code is normally permanently stored on a non-volatile storage medium such as a ROM (Read Only Memory), EPROM (Erasable Programmable Read Only Memory), or EEPROM (Electrically Erasable Programmable Read Only Memory). Instructions can be retrieved much faster from RAM than ROM. Therefore, during the boot up process of a computer the BIOS code is copied from the ROM to the main system memory of the computer and, when needed, executed from the main system memory.

Another modifiable storage medium is the flash memory (e.g. flash ROM). This type of memory allows for in-system reprogramming of the memory. When a computer system combines a reprogrammable non-volatile memory, such as an EEPROM or a flash memory, with a processor the computer system can be reprogrammed while in operation.

The ability to interactively upgrade and/or update (i.e. reprogram) instruction sets to a computer system may be very valuable. For instance, a company may service its customers without requiring the customer to bring the computer system to an authorized service center each time the firmware is to be reprogrammed.

Reprogramming of a reprogrammable non-volatile memory is known as “flashing”. Flashing of a memory permits the firmware to be replaced which permits the firmware to be upgraded and/or updated with new code or data. It is known in the art that flashing of a memory is performed by first erasing all code or data comprised in a memory area. This means that all bits of the memory area is put to a digital “1”, which is standard behavior when erasing a memory. Alternatively, all bits can be put to a digital “0”. After having put all bits to a digital “1”, the memory area is considered empty. The updating and/or upgrading of the memory is then accomplished by subsequently writing new code or data into the memory area.

A problem has been observed regarding flashing of memories. The flashing operation requires executable code to perform the erasure and the subsequent writing. This code, which is necessary to perform the flash, is normally included as part of the firmware comprised in the memory that is to be flashed. Before being rewritten the code residing in the firmware must be erased.

Consequently, a loss of power, or any other type of interruption during the flashing operation may render the storage medium unusable, and thus the computer system unusable. By way of example, if the power fails during the flashing of e.g. a flash ROM, the code that was first stored in the flash ROM is lost, because the flash process first erased the flash ROM. At this point the code to be upgraded or updated is gone from the firmware, and because that code contained the instructions necessary to perform the flash, the mechanism to perform the flash is also lost.

A flash ROM that experiences this problem may have to be reshipped to the vendor's factory, where necessary specialized equipment is used to reprogram the flash ROM or to replace the flash ROM with a flash ROM containing new code. This scenario is highly undesirable and inconvenient for the customer. Moreover, it also implies increased expenses for the customer.

It is known in the art that a simple way of ensuring a flashing process, which can be recovered in the event of power failure, is to always keep some part of the flash ROM intact, i.e. to keep some part of the flash ROM non-erasable. In this way, the part that is non-erasable will never be rewritten by new code or data. So, this part of the flash ROM is protected. The non-erasable part further contains the code that upon execution will overwrite the rest of the memory. In other words, the non-erasable block includes the instructions necessary to perform the flash.

Conventional flash parts or memories can be asymmetrical, in a sense that they are designed with different-sized blocks. Data is written into such flash parts or memories on a block-by-block basis. For example, there may be two 8-Kbyte blocks, one 16-Kbyte block, one 32-Kbyte block and a plurality of 64-Kbyte blocks. One of the 8-Kbyte blocks may contain information about the manufacturer (such as logotype, model number of the computer, etc.). The 16-Kbyte normally contains the protected boot code, which includes the code that upon execution will overwrite the rest of the memory.

The means for accessing any particular segment of a memory is known to persons who are ordinary skilled in the art. For example, one possible way of accessing a particular segment for rewriting is for the user to initiate a special erase command byte to any address location in the particular segment, that is to be updated or upgraded. For instance, this special erase command is initiated at the same time as a FLASH ENABLE pin of the memory is enabled by providing a certain voltage (e.g. 4 V or the like) to that pin. A similar process is then performed to allow writing to the particular segment, i.e. initiating a special write command byte to the particular segment while enabling the FLASH ENABLE pin. Other possible ways of selecting a particular segment of a memory for flashing are known in the art and will not be discussed further herein. It is nevertheless worth noting that the approaches may vary from manufacturer to manufacturer.

In the example above, the 16 K-byte block containing the boot code necessary for the flashing operation is typically the intact part. In other words, this block is typically not available for reprogramming.

As explained in U.S. Pat. No. 6,308,265 asymmetrical flash parts or memories are typically more expensive to manufacture than symmetrical ones. That is, a flash part having only multiple 64 K-byte blocks is cheaper to manufacture than a flash part having blocks with different sizes. However, since the necessary boot code that must be “protected” is typically around 16-Kbyte there is a very important trade-off that must be considered when manufacturing flash parts or memories. When manufacturing asymmetrical flash parts or memories it is possible to tailor-made a 16-Kbyte block containing only the boot code, which must be protected. Thus, no wasted memory space will occur. However, as previously explained the asymmetrical flash parts or memories are expensive. On the other hand, when manufacturing cheaper symmetrical flash parts or memories with only multiple blocks, e.g. 64-Kbyte-sized blocks, one of the blocks must contain the 16-Kbyte-sized boot code to be protected. Since the boot block code cannot be erased and then rewritten, if the boot block code was provided in the 64-Kbyte block, then that block would also have to include other code that cannot be erased and then rewritten so as to maximize the utilization of the available memory area; Alternatively, the remaining memory area of the 64-Kbyte block could remain empty and thus unutilized. Consequently, if the boot block code was 16 Kbytes in size, then the remaining area of the 64-Kbyte-block (i.e. 48 Kbytes) would either have to be unutilized (e.g. empty), or provided with code that cannot be updated.

The boot block code described previously may be considered to be the non-updateable portion of the BIOS code. The code that is updateable is typically placed contiguously with the non-updateable boot block code. While there may be portions of the BIOS code that are not updated very often, it may be desirable to update even that code from time to time. Therefore, one possible approach for protecting boot block code while allowing updating to BIOS code during a flash BIOS operation is suggested in U.S. Pat. No. 6,308,265. The boot block code is stored in a boot block or boot region of a flash part. Then a copy of the boot block code is written into another region of the flash part. The image of the boot block code in the another region is thereafter compared with the boot block code in the boot block. If there is a match, the boot block region is unprotected, thereby allowing an update of the boot code in the boot block. The boot block code in the flashed-in BIOS image in the boot block region is compared with the copy of the boot block code in the another region, and if there is a match, the code in the boot block region is protected. If there is not a match or if power fails, the system is booted up (i.e. restarted) using the boot block code in the another region.

However, there are a few disadvantages with the arrangement described in U.S. Pat. No. 6,308,265. According to U.S. Pat. No. 6,308,265, there is a comparison of new and old boot code, which means that the new code can never be different from the old code. In other words, the boot code is not fully updateable. Furthermore, the arrangement only allows for protection during a flashing process. Moreover, there is a need for a flag, which in turn may imply a need for an extra block of code (e.g. 8-Kbyte or larger). Consequently, you may in some circumstances need an extra storage medium like EEPROM. Still a further disadvantage with the arrangement described in U.S. Pat. No. 6,308,265 is that there is always a need for keeping an area of the flash part dedicated to the flashing process. This dedicated area must be at least of equal size as the boot block in order to accomplishing the copy operation.

There is a need for an improved method of flashing. Preferably an improved method of flashing allows updating and/or upgrading of firmware in a reprogrammable memory in a simpler, faster and more efficient way while at the same time allowing for safe flashing in that the flashing can be recovered in an event of interruption, e.g. a power failure. Preferably, an improved method of flashing does not need to always keep the necessary boot code intact. Consequently, an improved method of flashing preferably also allows updating of the boot code. It would also be desirable to accomplish a safe flashing with full overwriting. Furthermore, an improved method of flashing is preferably cost-effective when used in conjunction with any kind of memory, irrespective of whether it is an asymmetrical or symmetrical memory.

It is an object of the present invention to provide an improved flashing of a reprogrammable non-volatile storage medium.

This object has been accomplished by the provision of a method of flashing a reprogrammable non-volatile storage medium. The method comprises the steps of uploading a flashcode to a flash only area of said storage medium, and then verifying whether the flashcode has been uploaded correctly. If the flashcode has been uploaded correctly, a code segment of said storage medium is flashed. Then, it is verified whether the code segment has been written correctly. If the code segment is not written correctly, the code segment is flashed again.

The object has also been accomplished by the provision a computer readable program comprising program instructions for causing a computer to perform the method of flashing, as described above. Furthermore, the object has been accomplished by the provision of a carrier having thereon a computer readable program, which comprises computer implementable instructions for causing a computer to perform the above-mentioned method of flashing. Finally, the object has also been accomplished by the provision of a computer system that comprises input means, output means, storage means and processing means, and wherein the processing means is adapted to execute a computer readable program according the computer readable program previously described hereinabove.

The advantages with the present invention will become evident from the appended claims. For instance it will be evident that one major advantage with the present invention is that it provides a safe flashing, which can be recovered in the event of an interruption. Furthermore, it will become evident that it is always possible to “re-flash” the reprogrammable non-volatile storage medium, regardless of when an interruption, such as for example a power failure, occurs. A further advantage is that the invention also enables updating and/or upgrading of the instructions necessary to perform the flash. Still a further advantage with the invention is that it provides a safe flashing with full overwriting, i.e. overwriting of the full non-volatile storage medium to be flashed. Yet another advantage with the present invention is that it allows a more efficient and increasingly safe flashing in comparison with prior art. Finally, the flashing is also cost-effective when used in conjunction with any kind of memory, irrespective of whether it is an asymmetrical or symmetrical memory.

In the following discussion the present invention will be described in further detail in connection with preferred embodiments and with reference to the accompanying drawings, in which

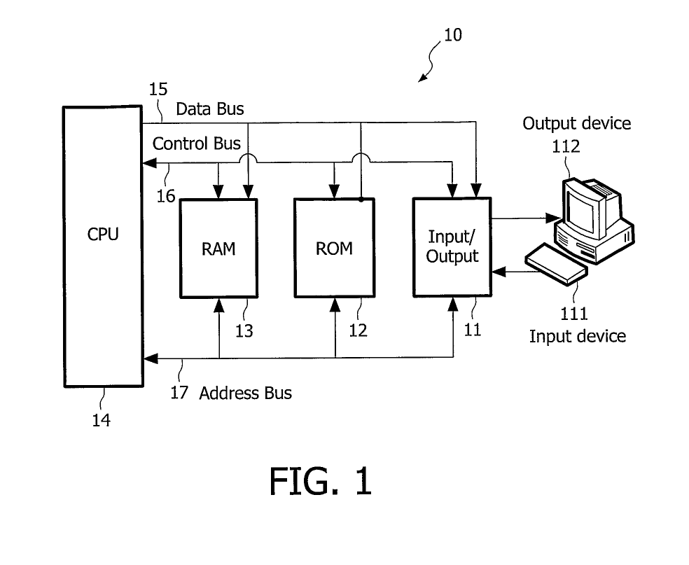

FIG. 1 illustrates a configuration of a basic computer system.

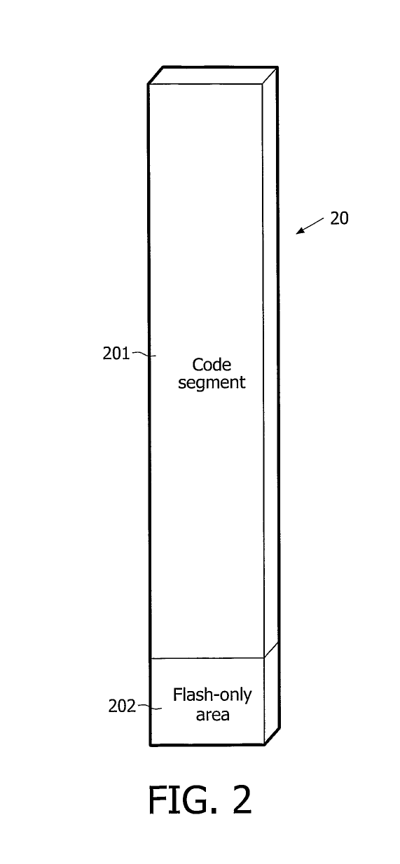

FIG. 2 illustrates a configuration of a flash ROM in accordance with a first embodiment of the invention.

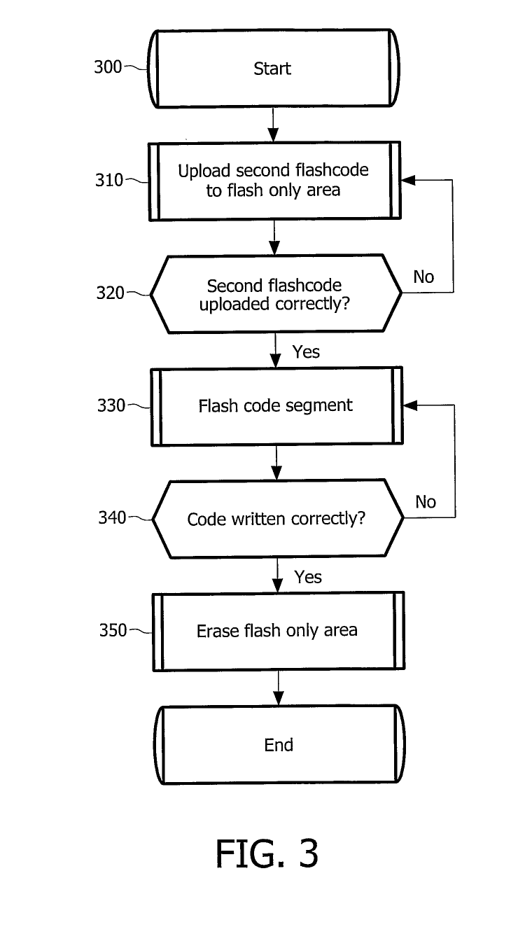

FIG. 3 illustrates a flow chart describing the flashing method according to the first embodiment of the invention.

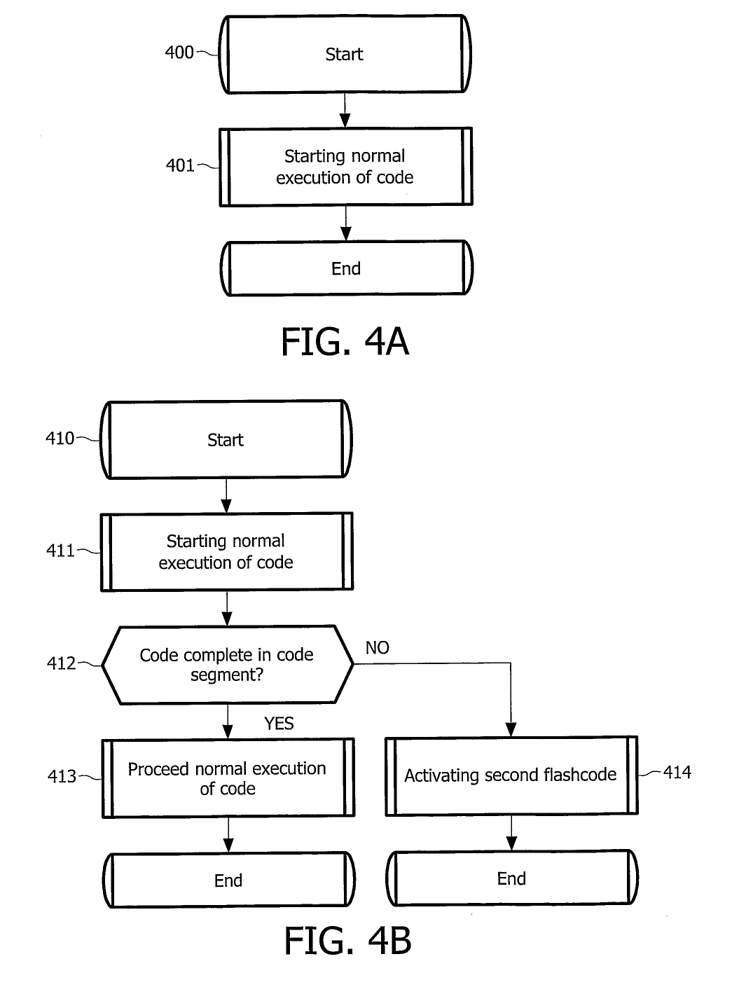

FIG. 4 illustrates different interruption scenarios according to the first embodiment of the invention in FIG. 4A and FIG. 4B, respectively.

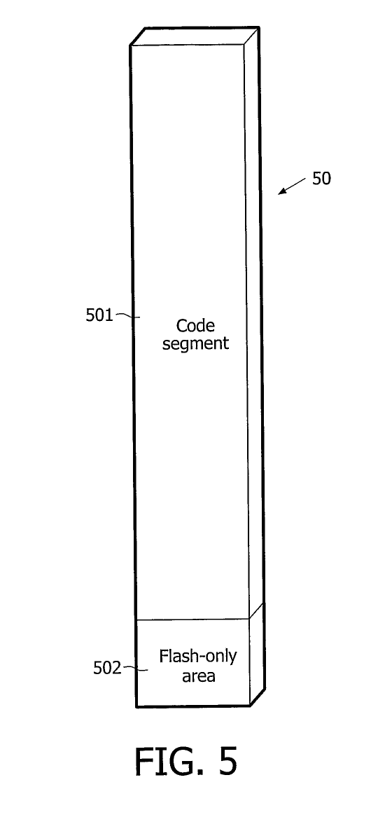

FIG. 5 illustrates a configuration of a flash ROM in accordance with a second embodiment of the invention.

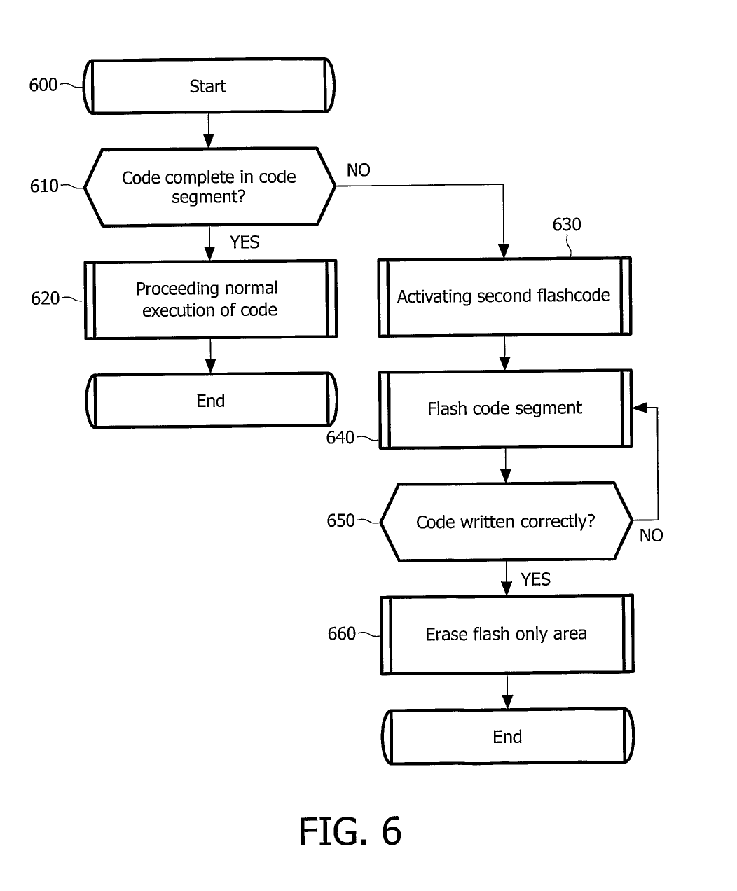

FIG. 6. illustrates a flow chart describing the flashing method according to the second embodiment of the invention.

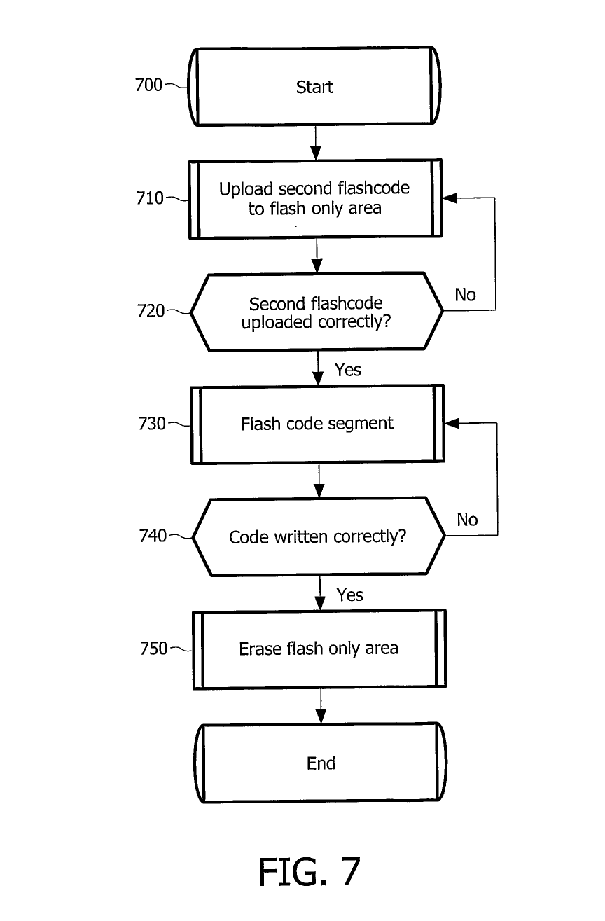

FIG. 7 illustrates a flow chart describing further steps of the flashing method according to the second embodiment of the invention, wherein this flow-chart is suitable when a code segment comprises a complete code.

FIG. 1 shows an overview of a basic computer system 10. Data and program information is supplied from an input device 111, and first stored in a secondary memory means 12, 13. Then the program is fetched by a CPU 14, which directs the flow of information in accordance with the program. For example, data can be supplied to a calculation unit 14 and processed, and then results are stored again in secondary memory means 12, 13. When this sequential processing is finished, processing results can be sent from secondary memory means 12, 13 to an output device 112 by instructions from a control unit 14. Data bus 15, control bus 16 and address bus 17 interconnect and transmit data between the different modules 11, 12, 13 and 14 of the computer system 10 as shown in FIG. 1. These buses 15, 16 and 17 can be distinguished by size: 8-bit, 16-bit, 32-bit, 64-bit, etc. A computer system configuration may be very complex and comprise many electronic components and sub-systems. This particular specification and claims will however mainly relate to the flashing of storage mediums that can be used in any computer system. The structure and operating principle of computer systems will thus not be explained in further detail herein. Moreover, it is emphasized that those of ordinary skill in the art know the basic structure and operating principle of such computer systems.

The invention will now be described in conjunction with, but is not limited to, two different embodiments. Furthermore, for illustrative purpose only, the invention will be described in conjunction with flash ROMs. It is emphasized that the invention can also be applied to other types of reprogrammable non-volatile storage mediums, such as for example EPROM or EEPROM.

A first preferred embodiment of the invention will now be described. FIG. 2 shows a configuration of a flash ROM 20 in accordance with a first embodiment of the invention. The flash ROM 20 comprises a code segment 201 and a flash only area 202. The code segment 201 comprises a block with boot code executable by the processing means 14 and at least one block with code for normal operation. Furthermore, it comprises a first flashcode, which could be executed by the processing means 14 for enabling flashing of the flash ROM. According to the first embodiment, the code segment 201 also comprises a block with a completeness check code, which is configured to check the completeness of the code segment 201. The block with boot code is normally located in the beginning of the code segment 201, while the block with the completeness check code can advantageously be placed in the end of the code segment 201. The flash only area 202 is configured to comprise a special flash only firmware. This firmware can be activated by the processing means 14. Moreover, the firmware is configured to accept only a minimal functionality to enable starting of a flashing operation. As such, the firmware may comprise a second flashcode for enabling flashing of the flash ROM 20. It should be understood that the flash only area is configured to be used only upon restart when a flashing operation has been interrupted by e.g. a power failure. When there is no need for the flash only area it can be cleared, i.e. made empty by erasing the area. This may be accomplished by any erasure technique generally known in the art. The provision of the flash only area consequently enables a flashing of the flash ROM to be recovered, irrespective of when an interruption occurs.

In accordance with the first embodiment, the processing means 14 is at least configured to execute a first flashcode in the code segment for initiating a flashing operation. Furthermore, the processing means 14 is configured to enable reflashing of the flash ROM by jumping to another address, if an interruption has occurred during a flashing operation. When an interruption is over and power is supplied the processing means is thus configured to activate the second flashcode, thereby enabling flashing of the flash ROM. In accordance with the first preferred embodiment, the processing means 14 further comprises a watchdog register, described later.

FIG. 3 is a flow-chart describing the flashing method according to the first embodiment of the invention. Normally, the processing means 14 starts executing boot code at a fixed address located in the code segment 201 of the flash ROM 20. When a flashing operation of the flash ROM, presumably to upgrade and/or update the firmware of the flash ROM, is initiated, e.g. by executing the first flashcode, a second flashcode is uploaded to the flash only area 202 in the first step, 310. When uploading, i.e. flashing, the second flashcode to the flash only area 202, the second flashcode is written into the flash only area 202, which allows for flashing of the code segment 201. In step 320, it is verified whether the second flashcode has been uploaded correctly to the flash only area 202. If the second flashcode has not been uploaded correctly in step 310, the second flashcode will be uploaded to the flash only area 202 again. In other words, the step of uploading the second flash code to the flash only area 202 will be retried until the uploading of the second flash code is successful. On the other hand, if the second flashcode has been uploaded correctly in step 320 the code segment 201 can be flashed with new code in step 330. In step 340 it is verified whether the new code has been correctly written into the code segment 201. If the code was not satisfactorily written into the code segment 201 the code segment 201 is flashed again. In other words, the step of flashing the code segment 201 will be retried until the flashing of the code segment 201 is successful. When the code is satisfactorily written into the code segment 201, the second flashcode comprised in the flash only area 202 could finally be erased in step 350. Consequently, the present method provides flashing with full overwriting in that all code of the flash ROM has been rewritten after a completed flashing.

In the following discussion a number of interruption scenarios will be explained in conjunction with FIG. 4A and FIG. 4B. Referring to FIG. 4A, if an interruption, such as a power failure, occurs during step 310 or 320, i.e. during the step of uploading the second flashcode to the flash only area 202 or during the step of verifying whether the second flashcode has been uploaded correctly, the execution of the flashing operation will be interrupted. When the interruption is over and power is supplied, normal execution of the code will start in step 401. This is because the code segment 201 has not been changed and the code comprised in the code segment 201 is the only code that is needed for normal operations. Thus, the flashing operation can be restarted in step 310.

Referring to FIG. 4B, if an interruption occurs in step 330 or 340, i.e. during the flashing of the code segment 201 or during the step when it is verified whether the code segment 201 has been written correctly, the execution of the flashing operation will be interrupted. When the interruption is over and power is supplied, normal execution of the code will start in step 411. In step 412, it is verified whether the code segment 201 comprises a complete code. If the code segment 201 comprises a complete code normal execution of the code will proceed in step 414. Thus, flashing can be reinitiated in step 310. If, on the other hand, the code segment 201 comprises corrupt code the second flashcode for renewed flashing of the code segment will be activated in step 415. The flash process can thus be restarted in step 310.

According to one preferred aspect of the first embodiment, verifying in step 413 whether the code segment 201 comprises a complete code comprises the step of executing the completeness check code comprised in the code segment 201 if this completeness check code is not corrupted itself. If the code segment 201 is complete, i.e. the code comprised therein is not corrupted, the watchdog register will be set to a valid value. Furthermore, the watchdog register can be checked by the processing means 14 and if the watchdog register is not set to the valid value it will be assumed that the code segment is corrupt. The step of checking the watchdog register is further performed within a predetermined time after step 412, i.e. after the step of starting normal execution of the code. The predetermined time is advantageously chosen to less than 1 second. Values of the predetermined time other than 1 second are of course possible within the scope of the invention, for example 0.5-2.5 seconds. Consequently, if the watchdog register is not set to the valid value before the watchdog register is checked by the processing means 14, it will be assumed that the code segment 201 comprises corrupted code. Accordingly, the second flashcode for renewed flashing of the code will be activated in step 415. On the other hand, if the watchdog register is set to the valid value in time it will be assumed that the code segment 201 comprises a complete code and normal execution of the code will thus proceed in step 414.

According to one aspect of the first embodiment, the completeness check of the code segment 201 can be accomplished by first calculating a checksum over the code comprised in the code segment 201, and thereafter comparing this checksum with a predetermined value that indicates a complete code. If the checksum is equal to the predetermined value it is assumed that the code segment 201 comprises a complete code. Alternatively, a checksum can be calculated over only a fraction of the code segment 201 or over selected parts (e.g. last 4 bytes) of the code segment 201, and thereafter comparing the calculated checksum with a predetermined value that indicates a complete code.

By way of example, if an interruption occurs in step 330, i.e. during the step of flashing the code segment 201, there is no complete code in the code segment 201 anymore. Therefore the watchdog register will not be set to the valid value in time, i.e. before the processing means 14 checks the watchdog register. Consequently the processing means 14 will activate the second flashcode in the flash only area 202 and the flashing operation can consequently be restarted. If an interruption occurs in step 340, i.e. during the step of verifying whether the code has been written correctly into the code segment 201, there are two possible scenarios. When the code segment has been flashed satisfactorily the normal execution of the code will start. Then the completeness check code will be executed. Since the code segment 201 comprises a complete code the watchdog register will be set to the valid value in time and then normal execution of the code can proceed. Accordingly, the flashing operation can be reinitiated in step 310. On the other hand, when the code segment 201 comprises corrupted code, the completeness check code will not be reached. Accordingly, the watchdog register will not be set to the valid value and the second flashcode will thus be activated. If there were only a few bytes corrupted, the completeness check code may be reached. However, it will then be found that the code segment 201 comprises corrupt code. The watchdog register will not be set to the valid value and the second flashcode will be activated. Consequently, the flashing operation can be recovered, thereby enabling reflashing of the code segment 201. The above described scenarios show that it will always be possible to recover the flashing, regardless of when there is a power failure, or any other interruption.

A second embodiment of the present invention will now be discussed. FIG. 5 shows a configuration of a flash ROM 50 in accordance with a second embodiment of the invention. The flash ROM 50 comprises a code segment 501 and a flash only area 502. The code segment 501 comprises a block with boot code executable by the processing means 14 and at least one block with code for normal operation. Furthermore, it comprises a first flashcode, which could be executed by the processing means 14 for enabling flashing of the flash ROM. However, contrary to the first embodiment, the code segment 501 comprises no block with a completeness check code. As was the case in the first embodiment, the flash ROM also comprises a flash only area. The flash only area 502 is configured to comprise a special flash only firmware. This firmware can be activated by the processing means 14 Moreover, the firmware is configured to accept only a minimal functionality to enable starting of a flashing operation. As such, the firmware may comprise a second flashcode for enabling flashing of the flash ROM. It should be understood that the flash only area is configured to be used only upon restart when a flashing operation has been interrupted by e.g. a power failure. When there is no need for the flash only area it can be cleared, i.e. made empty by erasing the area. Such erasure of the flash only area 502 can be accomplished by any erasure technique generally known in the art. The provision of the flash only area enables a flashing of the flash ROM to be recovered, irrespective of when an interruption occurs.

In accordance with the second embodiment, the processing means 14 is adapted to check the completeness of the code segment 501. It can do this by for example calculating a checksum over the code comprised in the code segment, and comparing this checksum with a predetermined value, which indicates a complete code. If there is a match, i.e. the checksum equals to the predetermined value, it is assumed that the code segment comprises a complete code. Alternatively, the checksum can be calculated over only a fraction of the code segment 501 or over selected parts (e.g. last 4 bytes) of the code segment 501. The processing means 14 is further configured to execute a first flashcode in the code segment for initiating a flashing operation. Furthermore, as was the case in the first embodiment of the invention, the processing means 14 is configured to enable reflashing of the flash ROM by jumping to another address if an interruption has occurred during a previous flashing operation. When an interruption is over and power is supplied the processing means is thus configured to activate the second flashcode, thereby enabling flashing of the flash ROM.

FIG. 6 and FIG. 7 are two flow-charts, which describe the flashing method according to the second embodiment. Normally, the processing means 14 starts executing boot code at a fixed address located in the code segment 501. However, in accordance with the second embodiment the processing means 14 will first verify in step 610 whether the code segment 501 comprises a complete code.

If it is verified in step 610 that the code segment 501 comprises a complete code normal execution of the code will proceed in step 620. With reference to FIG. 7, flashing can then be initiated from step 710. Consequently, when a flashing of the flash ROM 50, presumably to upgrade and/or update the firmware of the flash ROM 50, is later initiated, by e.g. executing the first flashcode, a second flashcode is uploaded to the flash only area 502 in step 710. When uploading, i.e. flashing, the second flashcode to the flash only area 502, the second flashcode is written into the flash only area 502, which allows for flashing of the code segment 501. In step 720, it is verified whether the second flashcode has been uploaded correctly to the flash only area 502. If the second flashcode has not been uploaded correctly in step 710, the second flashcode will be uploaded to the flash only area 502 again. In other words, the step of uploading the second flash code to the flash only area 502 will be retried until the uploading of the second flash code is successful. When the second flashcode has been uploaded correctly the code segment 501 can be flashed with new code in step 730. In step 740, it is then verified whether the new code has been correctly written into the code segment 501. If the code has not been satisfactorily written into the code segment 501 the code segment 501 is flashed again. In other words, the step of flashing the code segment 501 will be retried until the flashing of the code segment is successful. When the code is satisfactorily written into the code segment 501 the second flashcode comprised in the flash only area 502 could finally be erased in step 750.

When it is verified in step 610 that the code segment 501 comprises an incomplete code, i.e. corrupt code, normal execution of the code will not proceed. Instead the second flashcode will be activated in step 630 and the code segment 501 will be subsequently flashed in step 640. In the following step, 650, it is verified whether the flashing was satisfactory, i.e. whether the code has been written correctly into the code segment 501. If the code has not been written correctly into the code segment 501 the code segment 501 is flashed again. In other words, the step of flashing the code segment 501 will be retried until the flashing of the code segment 501 is successful. When it is verified that the code is satisfactorily written into the code segment 501 the second flashcode comprised in the flash only area 502 could finally be erased in step 660.

According to a preferred aspect of the second embodiment, verifying whether the code segment 501 has been written correctly in step 650 can be accomplished by comparing the code comprised in another storage medium, which comprises the code that should be written into the code segment 501, with the code that has been written into the code segment 501. The another storage medium can preferably be a RAM. From the above discussion it is clear that also the second embodiment of the present invention provides flashing with full overwriting in that all code of the flash ROM 50 has been rewritten after a completed flashing.

In the following discussion a number of interruption scenarios will be explained.

If an interruption occurs in step 630 or 640, i.e. during the activation of flashcode or during flashing of the code segment 501, the execution of the flashing operation will be interrupted. When the interruption is over and power is supplied, the processing means 14 will restart at step 610 and detect via the completeness check that the code segment 501 is corrupt. So, the second flashcode will be activated in step 630 thereby allowing for flashing the code segment 501 in step 640.

If an interruption occurs in step 650, i.e. the step of verifying whether the code segment 501 has been written correctly, the execution of the flashing operation will be interrupted. Now, there are two possibilities. When the interruption is over and power is supplied the process will start with a completeness check in step 610. If the code segment 501 was flashed satisfactorily, normal execution of the code will start in step 620 since the code segment comprises a complete code. Consequently, the flashing can then be reinitiated from step 710. If the code segment 501 was not flashed satisfactorily, the second flashcode will be activated in step 630 thereby allowing for flashing the code segment 501 in step 640.

If an interruption occurs during step 710 or 720, i.e. during uploading of the second flashcode to the flash only area 502 or during verifying whether the second flashcode has been uploaded correctly, the execution of the flashing operation will be interrupted. When the interruption is over and power is supplied the processing means 14 will restart with a completeness check in step 610. In step 610 it will be determined that the code segment 501 comprises a complete code. This is because the code segment 501 has not been changed. So, normal execution of the code will proceed in accordance with step 620. Flashing can thus be reinitiated from step 710.

If an interruption occurs in step 730, i.e. the step of flashing the code segment 501, the execution of the flashing operation will be interrupted. When the interruption is over and power is supplied the process will restart with a completeness check in step 610. In step 610 it will be determined that the code segment 501 comprises corrupt code. Consequently, the second flashcode will be activated in step 630 thereby allowing for flashing of the code segment 501 in step 640.

If an interruption occurs in step 740, i.e. the step of verifying whether the code has been written correctly into the code segment 501, the execution of the flashing operation will be interrupted. When the interruption is over and power is supplied the process will start with a completeness check in step 610. Now, there are two possibilities. If the code segment 501 was flashed satisfactorily in step 730, normal execution of the code will start in step 620 since the code segment 501 comprises a complete code. Consequently, the flashing can be reinitiated from step 710. If the code segment 501 was not flashed satisfactorily, i.e. the code segment 501 comprises corrupt code, it will be verified in step 610 that the code segment 501 is corrupt. So, the second flashcode comprised in the flash only area 502 will be activated in step 630 thereby allowing for flashing of the code segment 501 in step 640 in accordance with the second embodiment of the present invention.

The above described scenarios show that it will always be possible to recover the flashing in accordance with the second embodiment, regardless when there is a power failure or any other interruption.

In accordance with one aspect of the present invention the step of verifying whether the flashcode has been uploaded correctly is accomplished by comparing the code comprised in another storage medium, such as for example a RAM, which comprises the code that should be uploaded to the flash only area, with the flashcode that has been uploaded to the flash only area.

In accordance with yet another aspect of the present invention the steps of verifying whether the code segment has been written correctly are accomplished by comparing the code comprised in another storage medium, such as for example a RAM, which comprises the code that should be written into the code segment, with the code that has been written into the code segment.

The comparing steps previously described can preferably be accomplished by performing a byte-by-byte comparison. This can be accomplished by comparing the binary words and determine whether the compared bytes are equal to each other or not. If the bytes are equal to each other it is assumed that the code in the another storage medium corresponds to the code in the non-volatile storage medium. Alternatively, it is possible to calculate a first checksum over the code in the another storage medium, and a second checksum over the code in the non-volatile storage medium. Thereafter these checksums are compared. If the checksums are equal to each other it is assumed that the code in the another storage medium corresponds to the code in the non-volatile storage medium. Still a further alternative is to calculate a checksum over the code in the non-volatile storage medium and compare this checksum with a predetermined value, which indicates the code that should be written into the non-volatile storage medium.

Although the discussion has focused on two preferred embodiments of the invention for a complete disclosure, the appended claims are not to be thus limited but are to be construed as employing all modifications and alternative constructions that may occur to one skilled in the art which fairly fall within the basic herein set forth. For instance computer programs comprising program instructions for causing a computer to perform the method described in this specification are to be construed as falling within the scope of this disclosure. Also carriers of different kinds having thereon a computer program comprising computer implementable instructions for causing a computer to perform the method described in this specification are to be construed as falling within the scope of this disclosure. Therefore, any carrier such as for example a firmware, a record medium, a computer memory, a read-only memory or an electrical carrier signal is also to be construed as falling within the scope of this disclosure. Although the description has focused on flash ROMs, the invention could also be used in conjunction with other reprogrammable non-volatile storage mediums, such as for example EPROM or EEPROM.

The present invention could/should in particular be used in optical drives. Advantageously it can be used in the “dataref5” reference design of PHILIPS SEMICONDUCTORS. There are many possible applications in which the present invention could/should be used. For example, it could/should be used in applications such as personal computers, mobile cellular telephones, smartphones, Personal Digital Assistants (PDAs), electronic equipment, smart electronic appliances and equipment for kitchen, cleaning and outdoor use, consumer electronics, imaging equipment such as for example digital cameras, etc., when these applications employ a reprogrammable non-volatile memory. Consequently, all applications that comprises input means, output means, storage means and processing means, and wherein the processing means is adapted to execute computer programs comprising program instructions for causing the application to perform the method described in this specification are to be construed as falling within the scope of this disclosure. Finally, it is emphasized that the reference signs used throughout the following appended claims are not to be construed as limiting the scope of the present invention.

1. A method of flashing a reprogrammable non-volatile storage medium, wherein the method comprises the steps of:
uploading (310) a flashcode to a flash only area of said storage medium;
verifying (320) whether the flashcode has been uploaded correctly; if so
flashing (330) a code segment of said storage medium; and
verifying (340) whether the code segment has been written correctly; if it is not written correctly, flashing the code segment again.

2. A method according to claim 1, wherein the method, if the flashcode has not been uploaded correctly, comprises the further step of:
uploading (310) the flashcode to the flash only area again.

3. A method according to claim 1, wherein the method, if the code segment has been written correctly, comprises the further step of:
erasing (350) the flashcode in the flash only area.

4. A method according to claim 1, wherein the method, after having been interrupted during the step of uploading said flashcode or during the step of verifying whether the flashcode has been uploaded correctly, comprises the further step of:
restarting (401) normal execution of the code.

5. A method according to claim 1, wherein the method, after having been interrupted during the step of flashing the code segment or during the step of verifying whether the code segment has been written correctly, comprises the further steps of:
restarting (411) normal execution of the code; and
verifying (412) whether the code segment comprises a complete code, if not comprising a complete code activating (414) the flashcode for renewed flashing of the code segment; otherwise
proceeding (413) with normal execution of the code.

6. A method according to claim 5, wherein the step of verifying whether the code segment comprises a complete code comprises the steps of:
executing of a completeness check code in the code segment if said completeness check code is not corrupted, thereby checking the completeness of the code comprised in the code segment;
if the code segment is complete setting a watchdog register to a valid value;
checking the watchdog register within a predetermined time after the step of restarting normal execution of the code.

7. A method according to claim 6, wherein the method comprises the further step of:
proceeding with normal execution of the code when the watchdog register is valid; otherwise
activating the flashcode for renewed flashing of the code segment.

8. A method according to claim 6, wherein the step of checking the completeness of the code comprised in the code segment comprises the steps of:
calculating a checksum over the code comprised in the code segment, and
comparing this checksum with a predetermined value, which indicates a complete code.

9. A method according to claim 1, wherein the method, before the step of uploading the flashcode, comprises the further step of:
verifying (610) whether the code segment comprises a complete code, if it is not complete activating (630) the flashcode and flashing (640) the code segment.

10. A method according to claim 9, wherein the step of verifying whether the code segment comprises a complete code comprises the steps of:
calculating a checksum over the code comprised in the code segment, and
comparing this checksum with a predetermined value, which indicates a complete code.

11. A method according to claim 9, wherein the method comprises the further step of:
verifying (650) whether the code segment has been written correctly; if not flashing (640) the code segment again.

12. A method according to claim 11, wherein the step of verifying whether the code segment has been written correctly comprises the step of:
comparing the code comprised in another storage medium, which comprises the code that should be written into the code segment, with the code that has been written into the code segment.

13. A method according to claim 11, wherein the method, if the code segment has been written correctly, comprises the further step of:
erasing (660) the flashcode in the flash only area.

14. A method according to claim 9, wherein the method, if the code segment comprises a complete code, comprises the step of:
proceeding (620) with normal execution of the code.

15. A method according to claim 9, wherein the method—after having been interrupted—restarts with the step of:
verifying (610) whether the code segment comprises a complete code according to claim 9.

16. A method according to claim 1, wherein the step of verifying whether the flashcode has been uploaded correctly comprises the step of:
comparing the code comprised in another storage medium, which comprises the code that should be uploaded to the flash only area, with the flashcode that has been uploaded to the flash only area.

17. A method according to claim 1, wherein the step of verifying whether the code segment has been written correctly comprises the step of:
comparing the code comprised in another storage medium, which comprises the code that should be written into the code segment, with the code that has been written into the code segment.

18. A method according to claim 16, wherein the comparing step is performed by:
performing a byte-by-byte comparison.

19. A method according to claim 16, wherein the comparing step is performed by:
calculating a first checksum over the code in the another storage medium;
calculating a second checksum over the code in the non-volatile storage medium;
comparing the first and second checksums.

20. A method according to claim 16, wherein the comparing step is performed by:
calculating a checksum over the code in the non-volatile storage medium;
comparing the checksum with a predetermined value, which indicates the code that should be written into the non-volatile storage medium.

21. A method according to any claim 1, wherein the interruption is a power failure.

22. A computer readable program comprising program instructions for causing a computer to perform the method of claim 1.

23. A carrier having thereon a computer readable program comprising computer implementable instructions for causing a computer to perform the method according to claim 1.

24. A carrier according to claim 23, wherein said carrier is a firmware, a record medium, computer memory, read only memory or an electrical carrier signal.

25. A carrier according to claim 23, wherein said carrier is a reprogrammable non-volatile storage medium.

26. A carrier according to claim 23, wherein said reprogrammable non-volatile storage medium is a EPROM, EEPROM or a flash ROM.

27. A computer system comprising input means, output means, storage means and processing means, wherein said processing means is adapted to execute a computer readable program according to claim 22.
